(19) United States
(12) Patent Application Publication
(10) Pub. No.: US 2014/0156687 A1
(43) Pub. Date: Jun. 5, 2014

(54) IDENTIFYING DUPLICATE FILES

(71) Applicant: Qiliang Chen, Beijing (CN)

(72) Inventor: Qiliang Chen, Beijing (CN)

(21) Appl. No.: 13/149,548

(22) Filed: May 31, 2011

(51) Int. Cl. G06F 17/30; G06F 7/00

(52) U.S. Cl. 707/758; 707/803; 707/E17.014; 707/E17.044

(57) ABSTRACT

Methods, systems, and apparatus, including computer programs encoded on a computer storage medium, are provided for identifying duplicate data items. A method is provided that include the actions of identifying a file to be downloaded; determining that the size of the file exceeds a threshold value; in response to determining that the size of the file exceeds the threshold value, requesting one or more portions of the file, the one or more portions being less than the entire file; upon receiving the requested one or more portions of the file, constructing a file signature for the file based on the one or more portions of the file; determining whether the constructed signature exists in a file signature repository; if a matching file signature exists in the file signature repository, recording location information for the file to be downloaded as associated with the matching file signature.

### BACKGROUND

The present specification relates to identifying duplicate files.

A conventional search engine can crawl various pages on the web. Copies of the web pages can be cached in a local store at the search engine, e.g., for indexing. Many web pages include links through which users can download data items, for example, files including PDF files, spreadsheet files, or zipped files. A given file, for example, may be much larger than the web page itself. As part of the crawling process, the search engine can download the files linked to on these pages to make local copies, for example, to index the files for searching.

Duplicate files may be linked to on different web pages. These files may contain the exact same data, but have different file names or contain other information related to the file. Consequently, a conventional search engine can download multiple copies of the same file through the crawling process.

### SUMMARY

The present specification relates to identifying duplicate data items linked to by web pages.

In general, one aspect of the subject matter described in this specification can be embodied in methods that include the actions of identifying a file to be downloaded; determining that the size of the file exceeds a threshold value; in response to determining that the size of the file exceeds the threshold value, requesting one or more portions of the file, the one or more portions being less than the entire file; upon receiving the requested one or more portions of the file, constructing a file signature for the file based on the one or more portions of the file; determining whether the constructed signature exists in a file signature repository; if a matching file signature exists in the file signature repository, recording location information for the file to be downloaded as associated with the matching file signature.

Other embodiments of this aspect include corresponding systems, apparatus, and computer programs recorded on computer storage devices, each configured to perform the operations of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

These and other embodiments can each optionally include one or more of the following features. Determining that the size of the file exceeds the threshold value includes requesting a header of the file and comparing the size of the file identified in the header with the threshold value. The file signature repository maintains a list of file signatures, their corresponding files, and their respective file sizes. The file signature repository maintains a list of file signatures, links to their corresponding files, and their respective file sizes. The method further includes recording the name and location of the file to be downloaded in association with the matching file signature in the file signature repository. The one or more portions of the file include a beginning portion of the file having a specified size. The one or more portions of the file are each of a fixed size and are located at specified noncontiguous locations in the file. Constructing a file signature for the file includes: combining the one or more portions of the file into a whole binary string as the file signature. Constructing a file signature for the file includes: combining the one or more portions of the file into a whole binary string; and hashing on the binary string to obtain a binary value of a predetermined length as the file signature. Determining whether the constructed signature exists in a file signature repository includes: identifying entries in the file signature repository with the same file size as the file to be downloaded; and comparing the constructed file signature of the file to be downloaded with the file signature in each identified entry from the file signature repository to determine if there is a match. The method further includes: if there is no matching file signature already existing in the file signature repository, downloading the file in full; and recording the constructed file signature in the file signature repository as associated with the file.

In general, one aspect of the subject matter described in this specification can be embodied in methods that include the actions of downloading a file from a network location, the file having a size over a threshold value; extracting one or more portions of the downloaded file; constructing a file signature for the downloaded file using the one or more portions of the file; determining whether the file signature already exists in a signature repository; if the file signature does not exist, storing the downloaded file in a file storage; and storing the file signature in the file signature repository, wherein the file signature is associated with a link to the downloaded file in the file storage, the size of the file, and the network location from which the file was downloaded. Other embodiments of this aspect include corresponding systems, apparatus, and computer programs recorded on computer storage devices, each configured to perform the operations of the methods.

Particular embodiments of the subject matter described in this specification can be implemented so as to realize one or more of the following advantages. Duplication of downloaded files can be avoided efficiently using a signature comparison. Consequently, only a single version of a file is downloaded even if the file can be retrieved from multiple network locations.

Further embodiments, features, and advantages of the invention, as well as the structure and operation of the various embodiments of the invention are described in detail below with reference to accompanying drawings.

### BRIEF DESCRIPTION OF THE DRAWINGS

FIG. 1 illustrates a schematic overview of an example file download management system.

FIGS. 2A-2B are data structures of an example file signature repository.

FIGS. 3A-3B illustrate different example techniques for constructing file signatures using particular portions from files to be downloaded.

FIG. 4 shows a flow chart of an example process for identifying and recording duplicate files.

Like reference symbols in the various drawings indicate like elements.

### DETAILED DESCRIPTION

When a file linked to by a web page is to be retrieved (e.g., downloaded during a crawling process by a search engine), one or more portions of the file are downloaded to generate a file signature. The signature is compared to signatures stored in a repository. If the file signature matches a signature stored in the repository, the full file is not downloaded. Additionally, a reference can be added to a database identifying the source location of the duplicate file (e.g., for indexing). If the file signature does not match a signature in the repository, the full file is downloaded and the signature is added to the repository.

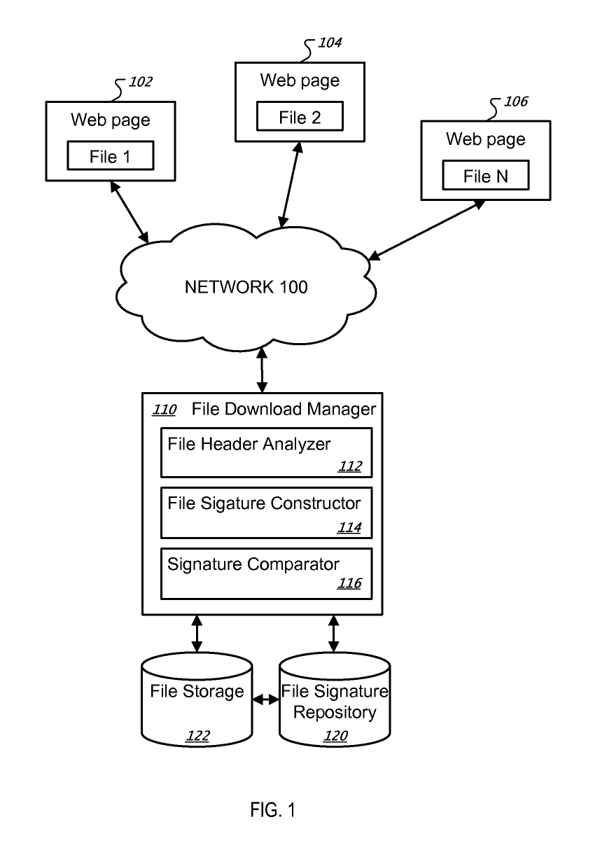

FIG. 1 illustrates a schematic overview of an example file download management system. In the file download management system, web pages 102, 104, and 106 are resources hosted at various network locations (e.g., on web servers) and are coupled to a file download manager 110 through a network 100. At least one file is referenced on each web page 102, 104, and 106, respectively. For example, each web page can include a hyperlink selectable by a user for downloading a corresponding file. Thus, when the particular web page is presented to a user (e.g., on a browser), the page content can include a link to a file that can be locally downloaded on the client device. These files can be, for example, text files, audio file, or video files, each of various sizes.

The file download manager 110 manages the downloading of these various data files from the web, e.g., for indexing along with the associated web pages 102, 104, and 106. The file download manager 110 includes a file header analyzer 112, a file signature constructor 114, and a signature comparator 116.

The file downloaded manager 110 is also coupled to a file storage 122 and a file signature repository 120. The file storage 122 stores the downloaded files (e.g., documents, videos, audio files). The file signature repository 120 maintains a list of file signatures for all of the downloaded files that are equal to or larger than a threshold size. In some implementations, the file storage 122 is a separate data table in a database management system, or a directory in a file system. In some other implementations, the file storage 122 is integrated with the file signature repository 120 in a single database.

In an example scenario in which the file storage 122 is a particular table in a database, the actual files can be stored in the database with a data type suitable for large files, such as a binary large object or “blob” data type. Alternatively, if the file storage 122 is a file directory in a file management system, the files can be stored in a particular directory and their respective directory paths will be stored in a corresponding file signature record in the file signature repository 120 for referencing.

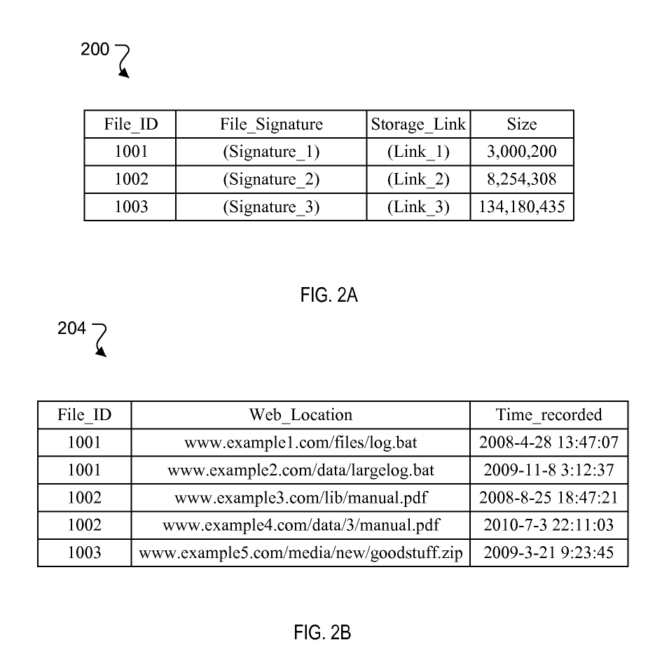

FIGS. 2A-2B are data structures of an example file signature repository (e.g., file signature repository 120). The example file signature repository includes two data tables. FIG. 2A shows a data table 200 including four data fields. The field “File_ID” is a unique identification number for a particular file. Field “File_Signature” stores a file signature for the particular file. The example file signatures are unique to respective files downloaded from the web.

The field “Storage_Link” stores the link to the actual file in the file storage as described above. The link can be, for example, a directory path of the corresponding file stored in a particular file system. In some implementations, the field “Storage_Link” is used to store the actual file as a blob type in the data table 200, instead of providing a link to an external file. The table 200 also includes a field “Size” that stores the size of each downloaded file. In some implementations, the data table 200 includes fields for storing additional information relating to a downloaded file, for example, a file type or a file name.

FIG. 2B shows a data table 204 in the example file signature repository. The data table 204 can be used to record the download information for the same file from different network locations. In this table, the field “File_ID” is the unique identification number of a downloaded file and can be used to join with the data table in FIG. 2A to obtain the detailed information of a downloaded file. The field “Web_Location” stores the web location from which the file as identified in the “File_ID” field is downloaded, for example, as a uniform resource locator (“URL”) address. The field “Time recorded” stores the time when the file was downloaded from a particular web location.

Other information relating to downloading of files from the web may also be recorded in the data table 204. Thus, for example, data table 204 shows two different “Web_Location” addresses for file 1001, two different “Web_Location” addresses for file 1002, and a single “Web_Location” address for file 1003. In particular, file 1001 can be downloaded once but the table 204 identifies each address location for instances of the same file.

In some alternative scenarios, the data tables in FIG. 2A and FIG. 2B can be implemented in a single data table for the same purpose of recording the downloading information of files and information of the downloaded files, including the downloaded file themselves. For example, data in the field “Storage_Link” can be a link referencing externally stored files, such that the same file is not stored in the database multiple times.

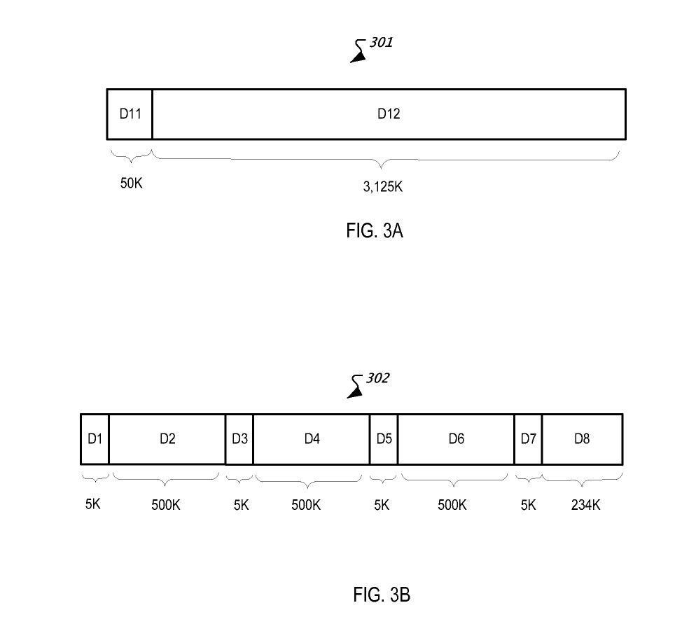

FIGS. 3A-3B illustrate different example techniques for constructing file signatures using particular portions from files to be downloaded on the web. In FIG. 3A, a sample file 301 of 3,175 kilobytes (k) is illustrated as having two blocks of data D11 and D12. In this example, a leading block D11 having 50 k of data can be selected to be downloaded by a file download manager. This block of data can then be used to construct a file signature for the file 301.

When requesting to download the leading 50 k of the file 301 using the HTTP protocol, the file download manager (e.g., file download manager 110 of FIG. 1) can send an HTTP request to the web server an HTTP in the following form:

GET /somddir/somefile.dat
Host:download.someserver.com
Accept:*/*
Pragma: no-cache
Cache-Control: no-cache
Referrer: http://somesite.com/somedir/somepage.htm
Range: bytes=0-51200

The last entry “Range: bytes=0-51200” in the above request specifies the particular portion in the file to be downloaded, i.e., the first 51,200 bytes of data in the file.

FIG. 3B shows another example technique for constructing a file signature. In this example, the file 302 to be downloaded has a total size of 1,749 k. To construct a file signature for file 302, the file download manager can download multiple selected portions of data in this file. In this example, each of the blocks D1, D3, D5, and D7 have the same 5 k size. These blocks are noncontiguous, being spaced apart at an equal distance of 500 k bytes. However, in some alternative implementations, the spacing is variable or zero between two or more blocks. The file download manager downloads only the blocks of data in D1, D3, D5, and D7 to construct a file signature for the file 302, without downloading the remaining blocks of D2, D4, D6, and D8. In some alternative implementations, the entire file 302 is downloaded and then parsed to examine the particular blocks of interest while discarding the remainder.

When requesting to download a portion of 5 k bytes in the file 302 using the HTTP protocol, for example, block D3 in the file 302, the file download manager can send an HTTP request to the web server in the following form:

GET /somddir/somefile.dat HTTP/1.1
Host:download.someserver.com
Accept:*/*
Pragma: no-cache
Cache-Control: no-cache
Referrer: http://somesite.com/somedir/somepage.htm
Range: bytes=517121-522241

In the above sample code, the code “Range: bytes=517121-522241” specifies a particular block of data in the file to be downloaded. Other portions of the file 302 can be downloaded in similar format using the HTTP protocol. Thus, a sequence of requests can be sent, one for each of blocks D1, D3, D5, and D7 of the file 302. Alternatively, in some implementations, a single request identifies each of the blocks of data to be downloaded.

In some other implementations, the portions of the file to be downloaded are chosen by employing a different technique. For example, the length of each downloaded portion can be set to different sizes and/or the distances between these portions can be set to distances other than equal distances. Consequently, as long as the downloaded portions in total are distinctive enough to uniquely identify the file, the portions of the file can be downloaded in a time much shorter than the entire file allowing for efficient construction of a file signature. Once the particular technique for selecting a particular portion or portions of a file is specified for the file download management system, the same technique can be used in all the downloading activities of the system to ensure that all constructed file signature follows the same technique.

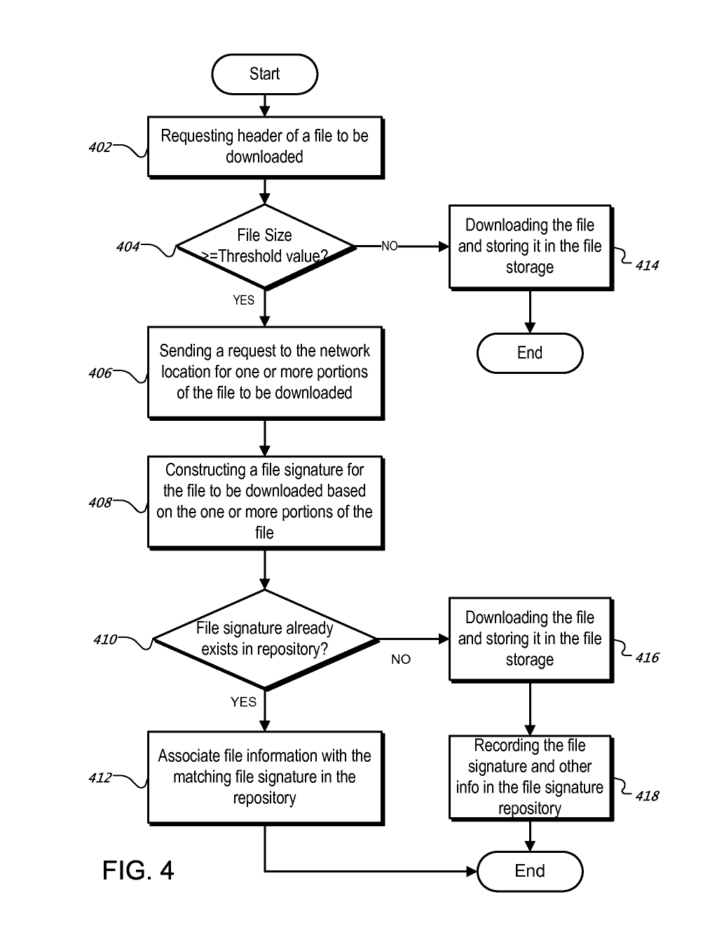

FIG. 4 shows a flow chart of an example process 400 for identifying and recording duplicate files in downloading a file from a web resource. For convenience, the process 400 will be described with respect to a system, including one or more computing devices, that performs the process 400. In some implementations, the process 400 can be performed by the file download manager 110 of FIG. 1.

Upon identifying in a web page that a particular link existed that is directs to a downloadable file, the system requests file information. In particular, the system requests header information for the file (402). The system can issue an HTTP request to the web server hosting the file requesting for the header information of this file, particularly the size of the file. For example, if the link shows that a file “file1.dat” is hosted at the network location www.testserver.com under the directory “/test/dir/”, the system can issue the following HTTP request:

GET /test/dir/file1.dat HTTP/1.1
Host: www.testserver.com
User-Agent: Mozilla/5.0 (Windows;en-GB; rv:1.8.0.11) Gecko/20070312
Firefox/1.5.0.11
Accept: text/xml,text/html;q=0.9,text/plain;q=0.8,image/png,*/*;q=0.5
Accept-Language: en-gb,en;q=0.5
Accept-Encoding: gzip,deflate
Accept-Charset: ISO-8859-1,utf-8;q=0.7,*;q=0.7
Keep-Alive: 300
Connection: keep-alive
Referrer: http://www.some_url.com/directory/page

The web server hosting the file returns information relating to the file. The returned information can be in the following form:

HTTP/1.1 200 OK
Server: Server_program_name
Date: Mon, 04 Oct 2004 12:04:43 GMT
Cache-Control: no-cache
Pragma: no-cache Expires: −1
Content-Type: text/html; charset=utf-8
Content-Length: 1,790,976

The part “Content-length” and its value identify the size of the file to be downloaded (i.e., 1,790,976 bytes).

The system compares the obtained size of the file to be downloaded to a specified threshold size (404). If the obtained size of the file exceeds this threshold size, a determination is made of whether the same file has already been downloaded from another web location to avoid possible downloading and storing of duplicate copies of the same file. The threshold size can be set, for example to 100 k. However, the threshold can be set to smaller or larger values based on the different system requirements.

When the file size is smaller than the threshold value, the system downloads the file directly and stores it in file storage (414). A file size smaller than the threshold value can indicate that the file is small enough to be downloaded quickly. Therefore, constructing a file signature for such a small file and comparing it with some stored file signatures may be less efficient than downloading the file directly even if duplicates are stored. The file can be stored together with some other related information, for example, the web location from which it was downloaded, the file size, or download time.

If the file size of the file to be downloaded is equal to or greater than the predetermined threshold value, a file signature for this file is constructed and compared with a stored list of file signatures to identify if there is any matching file signature. To construct the file signature, the system sends a request to the location hosting the file for one or more portions of the file (406). Depending on different techniques for constructing a file signature, one portion or multiple portions of the file are downloaded, for example, as set forth above with respect to FIGS. 3A and 3B.

For example, using the technique illustrated in FIG. 3B for constructing a file signature, based on the received file size, for example, identified from received file header information. For example, the file of FIG. 3B can correspond to the file described above with respect to example file header information and having a file size of 1,790,976 bytes. A file signature constructor (e.g., file signature constructor 114) can calculate the ranges of the specific portions of the file to be downloaded and obtain the following results:
D1 (1-5120);
D3 (517,121-522,240);
D5 (1,034,241-1,039,360); and
D7 (1,551,361-1,556,480).
   Four separate requests for these particular ranges of the file can be created and sent to the web server hosting the web page and respectively downloaded.

The system constructs a file signature for the file based on one or more portions of the file (408). For example, upon receiving the four portions of the file (D1, D3, D5 and D7), system can assemble these four portions into a whole string of consecutive binary digits. In some implementations, this assembled string of binary digits is treated as the file signature of the file to be downloaded.

Alternatively, to ensure that the constructed file signature is of a fixed and shorter length, a hashing function can be further performed on the assembled string of binary digits. For example, a Message Digest Algorithm (MD5) may be employed to hash the binary string to obtain a 128-bit value, which can be used as the file signature for the file to be downloaded. Similarly, with regard to the example as shown in FIG. 3A, the first portion D11 of the file may be downloaded and used directly as the file signature, or may similarly be hashed to a 128-bit value to be used as the file signature for the file to be downloaded.

The system determines whether the constructed file signature already exists in a repository (410). In particular, the system compares the constructed file signature with the existing file signatures in the file signature repository to identify whether a matching file signature exists in the repository. The comparison can be performed, for example, using a signature comparator (e.g., signature comparator 116) of the file download manager.

If a matching file signature is found in the file signature repository, which means the same file has been previously downloaded from some other web location, the current file is not downloaded again. The system associates file information with the matching file signature in the repository (412). For example, the web location of the file, the time the file is attempted to be downloaded, etc., can be recorded in the file signature repository and associated with the matching file signature existing in the repository. In the example as shown in FIG. 2B, the second entry in the data table 204 provides information for a file with a File_ID of “1001” which already exists in the repository.

Alternatively, if it is determined at step 410 that no matching file signature is found in the file signature repository, which means that a file identical to the file to be downloaded has not been previously downloaded, the system downloads the entire file directly from the web server hosting the file and stores it in file storage (416). The system can also record additional information associated with the file, for example, the web location of the file, the file size, the time the file is downloaded, in the file signature repository in association with the entry for the stored file (418). Alternatively, these two steps may be performed in a reverse order or simultaneously.

The file signature repository constructed in this manner can further be used by one or more other applications, for example, a search engine, for indexing and searching purposes.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method, comprising:
identifying a downloadable file from a first network location;
determining that the size of the file exceeds a threshold value;
in response to determining that the size of the file exceeds the threshold value, determining whether the file is a duplicate of a previously stored file from a second network location, the determining comprising:
requesting one or more portions of the file from the first network location, the one or more portions being less than the entire file;
upon receiving the requested one or more portions of the file, constructing a file signature for the file based on the one or more portions of the file;
determining whether to download the complete file including determining whether the constructed signature constructed from the one or more received portions of the file exists in a file signature repository; and
if it is determined that the constructed file signature matches a file signature that exists in the file signature repository, the file signature being associated with the stored file, determining that the downloadable file is a duplicate file of the stored file, wherein as a result of the determination, the duplicate file is not downloaded and location information for the duplicate file at the first network location is recorded as associated with the matching file signature of the stored file.

2. The method of claim 1, where determining that the size of the file exceeds the threshold value includes requesting a header of the file and comparing the size of the file identified in the header with the threshold value.

3. The method in claim 1, wherein the file signature repository maintains a list of file signatures, their corresponding files, and their respective file sizes.

4. The method in claim 3, wherein the file signature repository maintains a list of file signatures, links to their corresponding files, and their respective file sizes.

5. The method of claim 4, further comprising: recording the name and location of the file to be downloaded in association with the matching file signature in the file signature repository.

6. The method of claim 1, wherein the one or more portions of the file include a beginning portion of the file having a specified size.

7. The method of claim 1, wherein the one or more portions of the file are each of a fixed size and are located at specified noncontiguous locations in the file.

8. The method of claim 1, wherein constructing a file signature for the file comprises:
combining the one or more portions of the file into a whole binary string as the file signature.

9. The method of claim 1, wherein constructing a file signature for the file comprises:
combining the one or more portions of the file into a whole binary string; and
hashing on the binary string to obtain a binary value of a predetermined length as the file signature.

10. The method of claims 1, wherein determining whether the constructed signature exists in a file signature repository comprises:
identifying entries in the file signature repository with the same file size as the file to be downloaded; and
comparing the constructed file signature of the file to be downloaded with the file signature in each identified entry from the file signature repository to determine if there is a match.

11. The method of claim 1, further comprising:
if there is no matching file signature already existing in the file signature repository, downloading the file in full; and
recording the constructed file signature in the file signature repository as associated with the file.

12. A method, comprising:
identifying in a web page a link to a downloadable file from a first network location, the file having a size over a threshold value;
determining whether the downloadable file is a duplicate of a previously stored file from a second network location, the determining comprising:
requesting one or more noncontiguous portions of the downloadable file from the first network location without receiving one or more additional portions of the downloadable file;
constructing a file signature for the downloadable file using the one or more portions of the file;
determining whether the file signature already exists in a signature repository, wherein determining whether the file signature already exists in the signature repository includes comparing the constructed file signature with existing signatures in the signature repository;
if it is determined that the file signature exists in the signature repository, the downloadable file is determined to be a duplicate of the stored file and in response to the determination that the downloadable file is a duplicate, the file is not downloaded and location information for the downloadable file at the first network location is recorded as associated with the matching file signature of the stored file; and
if it is determined that the file signature does not exist in the signature repository, the file is determined not to be a duplicate of the stored file, wherein in response to the determination that the downloadable file is not a duplicate:
downloading the file and storing the downloaded file in a file storage; and
storing the file signature in the file signature repository, wherein the file signature is associated with a link to the downloaded file in the file storage and the first network location from which the file was downloaded.

13. A system comprising:
one or more computing devices configured to perform operations comprising:
identifying a downloadable file from a first network location;
determining that the size of the file exceeds a threshold value;
in response to determining that the size of the file exceeds the threshold value, determining whether the file is a duplicate of a previously stored file from a second network location, the determining comprising:
requesting one or more portions of the file from the first network location, the one or more portions being less than the entire file;
upon receiving the requested one or more portions of the file, constructing a file signature for the file based on the one or more portions of the file;
determining whether to download the complete file including determining whether the constructed signature constructed from the one or more received portions of the file exists in a file signature repository; and
if it is determined that the constructed file signature matches a file signature that exists in the file signature repository, the file signature being associated with the stored file, determining that the downloadable file is a duplicate file of the stored file, wherein as a result of the determination, the duplicate file is not downloaded and location information for the duplicate file at the first network location is recorded as associated with the matching file signature of the stored file.

14. The system of claim 13, where determining that the size of the file exceeds the threshold value includes requesting a header of the file and comparing the size of the file identified in the header with the threshold value.

15. The system in claim 13, wherein the file signature repository maintains a list of file signatures, their corresponding files, and their respective file sizes.

16. The system in claim 15, wherein the file signature repository maintains a list of file signatures, links to their corresponding files, and their respective file sizes.

17. The system of claim 16, further configured to perform operations comprising: recording the name and location of the file to be downloaded in association with the matching file signature in the file signature repository.

18. The system of claim 13, wherein the one or more portions of the file include a beginning portion of the file having a specified size.

19. The system of claim 13, wherein the one or more portions of the file are each of a fixed size and are located at specified noncontiguous locations in the file.

20. The system of claim 13, wherein constructing a file signature for the file comprises:
combining the one or more portions of the file into a whole binary string as the file signature.

21. The system of claim 13, wherein constructing a file signature for the file comprises:
combining the one or more portions of the file into a whole binary string; and
hashing on the binary string to obtain a binary value of a predetermined length as the file signature.

22. The system of claims 13, wherein determining whether the constructed signature exists in a file signature repository comprises:
identifying entries in the file signature repository with the same file size as the file to be downloaded; and
comparing the constructed file signature of the file to be downloaded with the file signature in each identified entry from the file signature repository to determine if there is a match.

23. The system of claim 13, further configured to perform operations comprising:
if there is no matching file signature already existing in the file signature repository, downloading the file in full; and
recording the constructed file signature in the file signature repository as associated with the file.

24. A system comprising:
one or more computing devices configured to perform operations comprising:
identifying in a web page a link to a downloadable file from a network location, the file having a size over a threshold value;
determining whether the downloadable file is a duplicate of a previously stored file from a second network location, the determining comprising:
requesting one or more noncontiguous portions of the downloadable file from the first network location without receiving one or more additional portions of the downloadable file;
constructing a file signature for the downloadable file using the one or more portions of the file;
determining whether the file signature already exists in a signature repository, wherein determining whether the file signature already exists in the signature repository includes comparing the constructed file signature with existing signatures in the signature repository;
if it is determined that the file signature exists in the signature repository, the downloadable file is determined to be a duplicate of the stored file and in response to the determination that the downloadable file is a duplicate, the file is not downloaded and location information for the downloadable file at the first network location is recorded as associated with the matching file signature of the stored file; and
if it is determined that the file signature does not exist in the signature repository, the file is determined not to be a duplicate of the stored file, wherein in response to the determination that the downloadable file is not a duplicate:
downloading the file and storing the downloaded file in a file storage; and
storing the file signature in the file signature repository, wherein the file signature is associated with a link to the downloaded file in the file storage and the first network location from which the file was downloaded.

25. A non-transitory computer storage medium encoded with a computer program, the program comprising instructions that when executed by data processing apparatus cause the data processing apparatus to perform operations comprising:
identifying a downloadable file from a first network location;
determining that the size of the file exceeds a threshold value;
in response to determining that the size of the file exceeds the threshold value, determining whether the file is a duplicate of a previously stored file from a second network location, the determining comprising:
requesting one or more portions of the file from the first network location, the one or more portions being less than the entire file;
upon receiving the requested one or more portions of the file, constructing a file signature for the file based on the one or more portions of the file;
determining whether to download the complete file including determining whether the constructed signature constructed from the one or more received portions of the file exists in a file signature repository; and
if it is determined that the constructed file signature matches a file signature that exists in the file signature repository, the file signature being associated with the stored file, determining that the downloadable file is a duplicate file of the stored file, wherein as a result of the determination, the duplicate file is not downloaded and location information for the duplicate file at the first network location is recorded as associated with the matching file signature of the stored file.

26. The computer storage medium of claim 25, where determining that the size of the file exceeds the threshold value includes requesting a header of the file and comparing the size of the file identified in the header with the threshold value.

27. The computer storage medium in claim 25, wherein the file signature repository maintains a list of file signatures, their corresponding files, and their respective file sizes.

28. The computer storage medium in claim 27, wherein the file signature repository maintains a list of file signatures, links to their corresponding files, and their respective file sizes.

29. The computer storage medium of claim 28, further comprising instructions that when executed by data processing apparatus cause the data processing apparatus to perform operations comprising: recording the name and location of the file to be downloaded in association with the matching file signature in the file signature repository.

30. The computer storage medium of claim 25, wherein the one or more portions of the file include a beginning portion of the file having a specified size.

31. The computer storage medium of claim 25, wherein the one or more portions of the file are each of a fixed size and are located at specified noncontiguous locations in the file.

32. The computer storage medium of claim 25, wherein constructing a file signature for the file comprises:
combining the one or more portions of the file into a whole binary string as the file signature.

33. The computer storage medium of claim 25, wherein constructing a file signature for the file comprises:
combining the one or more portions of the file into a whole binary string; and
hashing on the binary string to obtain a binary value of a predetermined length as the file signature.

34. The computer storage medium of claims 25, wherein determining whether the constructed signature exists in a file signature repository comprises:
identifying entries in the file signature repository with the same file size as the file to be downloaded; and
comparing the constructed file signature of the file to be downloaded with the file signature in each identified entry from the file signature repository to determine if there is a match.

35. The computer storage medium of claim 25, further comprising instructions that when executed by data processing apparatus cause the data processing apparatus to perform operations comprising:
if there is no matching file signature already existing in the file signature repository, downloading the file in full; and
recording the constructed file signature in the file signature repository as associated with the file.

36. A non-transitory computer storage medium encoded with a computer program, the program comprising instructions that when executed by data processing apparatus cause the data processing apparatus to perform operations comprising:
identifying in a web page a link to a downloadable file from a network location, the file having a size over a threshold value;
determining whether the downloadable file is a duplicate of a previously stored file from a second network location, the determining comprising:
requesting one or more noncontiguous portions of the downloadable file from the first network location without receiving one or more additional portions of the downloadable file;
constructing a file signature for the downloadable file using the one or more portions of the file;
determining whether the file signature already exists in a signature repository, wherein determining whether the file signature already exists in the signature repository includes comparing the constructed file signature with existing signatures in the signature repository;
if it is determined that the file signature exists in the signature repository, the downloadable file is determined to be a duplicate of the stored file and in response to the determination that the downloadable file is a duplicate, the file is not downloaded and location information for the downloadable file at the first network location is recorded as associated with the matching file signature of the stored file; and
if it is determined that the file signature does not exist in the signature repository, the file is determined not to be a duplicate of the stored file, wherein in response to the determination that the downloadable file is not a duplicate:
downloading the file and storing the downloaded file in a file storage; and
storing the file signature in the file signature repository, wherein the file signature is associated with a link to the downloaded file in the file storage and the first network location from which the file was downloaded.
